(19) United States
(12) Patent Application Publication
(10) Pub. No.: US 2006/0174283 A1
(43) Pub. Date: Aug. 3, 2006

(54) Integrated tuner for satellite and terrestrial broadcast reception

(75) Inventor: Yuhichi Ieshima, Osaka (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/329,193

(22) Filed: Jan. 11, 2006

(30) Foreign Application Priority Data
Jan. 31, 2005 (JP) 2005-23639

(51) Int. Cl. H04N 7/20; H04N 5/38

(52) U.S. Cl. 725/68; 725/63; 348/723

(57) ABSTRACT

A satellite and terrestrial broadcast reception integrated tuner of the invention includes a satellite broadcast reception tuner circuit and a terrestrial broadcast reception tuner circuit. The satellite broadcast reception tuner circuit includes a filter circuit that attenuates a signal having a frequency lower than the satellite broadcast reception band and a quadrature detection circuit to which the output of the filter circuit is directly inputted. With this configuration, the interference of the terrestrial broadcast reception tuner circuit with the satellite broadcast reception tuner circuit is reduced.

### This nonprovisional application claims priority under 35 U.S.C. § 119(a) on Patent

Application No. 2005-023639 filed in Japan on Jan. 31, 2005, the entire contents of which are hereby incorporated by reference.

### BACKGROUND OF THE INVENTION

1. Field of the Invention

The present invention relates to an integrated tuner provided with a satellite broadcast reception tuner circuit and a terrestrial broadcast reception tuner circuit.

2. Description of Related Art

Conventionally, satellite broadcast reception tuners and terrestrial broadcast reception tuners were supplied as separate units. As television receivers and sets are made increasingly compact, there have emerged integrated tuners for satellite and terrestrial broadcast reception that have the just-mentioned two types of tuner integrated into a single unit (see, for example, Japanese Patent Application Laid-open No. H3-46827). Now, a description will be given of a conventional satellite and terrestrial broadcast reception integrated tuner.

FIG. 6 is a diagram schematically showing an example of the configuration of a conventional satellite and terrestrial broadcast reception integrated tuner. The conventional satellite and terrestrial broadcast reception integrated tuner shown in FIG. 6 has a satellite broadcast reception tuner circuit 2 and a terrestrial broadcast reception tuner circuit 3 housed inside a shield case 1.

The satellite broadcast reception tuner circuit 2 is connected to an RF input terminal 4 and to output terminals 8 and 9, and includes a high-pass filter (hereinafter “HPF”) 5, an RF amplifier 6, and a quadrature detection circuit 7. An input signal fed in via the RF input terminal 4 first has its other than high-frequency components eliminated by the HPF 5, is then amplified by the RF amplifier 6, and is then converted by the quadrature detection circuit 7 into two baseband signals 90° out of phase with each other. The quadrature detection circuit 7 feeds one of the baseband signals to the output terminal 8 and the other to the output terminal 9.

The terrestrial broadcast reception tuner circuit 3 is connected to an RF input terminal 10 and to an output terminal 14, and includes a HPF 11, an RF amplifier 12, and a frequency conversion circuit 13. The frequency conversion circuit 13 includes, for example, a local oscillator, a PLL circuit that controls the local oscillator, and a mixer that mixes together the output of the RF amplifier 12 and the output of the local oscillator. An input signal fed in via the RF input terminal 10 first has its other than high-frequency components eliminated by the HPF 11, is then amplified by the RF amplifier 12, and is then down-converted by the frequency conversion circuit 13 into an IF signal. The frequency conversion circuit 13 feeds the IF signal to the output terminal 14.

Exactly because the satellite broadcast reception tuner circuit 2 and the terrestrial broadcast reception tuner circuit 3 are integrated into a single unit, the conventional satellite and terrestrial broadcast reception integrated tuner shown in FIG. 6 is prone to degraded characteristics caused by interference by oscillation signals and distortion produced between the tuner circuits themselves. What is particularly troublesome is that, when an input signal to the terrestrial broadcast reception tuner circuit 3 is amplified by the RF amplifier 12, harmonics or distorted components of the input signal are produced. If these harmonics or distorted components of the input signal enter the satellite broadcast reception tuner circuit 2, and if their frequencies are in the satellite broadcast reception band, they cause degraded characteristics. Even if the frequencies of the harmonics or distorted components of the input signal are lower than the satellite broadcast reception band, if their frequency sum components lie in the satellite broadcast reception band, they cause degraded characteristics.

Japanese Utility Model Application Laid-open No. S62-73572 discloses a circuit board for an electronic appliance, and this utility model is so devised as to minimize the lowering of the strength of a circuit board on which conductor patterns forming different circuits (for example, an input select circuit and an RF modulator circuit) are separated from one another. This utility model, however, is not configured to cope with a plurality of tuner circuits being formed (see the “Technical Field”section of Japanese Utility Model Application Laid-open No. S62-73572). Thus, the circuit board for an electronic appliance disclosed in Japanese Utility Model Application Laid-open No. S62-73572 is free from degraded characteristics caused by interference by oscillation signals and distortion produced between tuner circuits themselves. On the other hand, Japanese Patent Applications Laid-open Nos. H3-46827 and H7-38827 disclose tuners, and these inventions are so devised as to prevent mutual interference between an up-conversion section (a tuner circuit) and a down-conversion section (an IF section). These inventions, however, do not involve a plurality of tuner circuits. Thus, the tuners disclosed in Japanese Patent Applications Laid-open Nos. H3-46827 and H7-38827 are free from degraded characteristics caused by interference by oscillation signals and distortion produced between tuner circuits themselves.

### SUMMARY OF THE INVENTION

An object of the present invention is to provide a satellite and terrestrial broadcast reception integrated tuner in which the interference of a terrestrial broadcast reception tuner with a satellite broadcast reception tuner is reduced.

To achieve the above object, according to one aspect of the present invention, a satellite and terrestrial broadcast reception integrated tuner is provided with: a satellite broadcast reception tuner circuit; and a terrestrial broadcast reception tuner circuit. Here, the satellite broadcast reception tuner circuit includes: a filter circuit that attenuates a signal having a frequency lower than the satellite broadcast reception band; and a frequency conversion circuit to which the output of the filter circuit is directly inputted. With this configuration, an unnecessary signal having a frequency lower than the satellite broadcast reception band is less likely to enter the frequency conversion circuit. Thus, it is possible to reduce the degradation of characteristics caused by an unnecessary signal produced in the terrestrial broadcast reception tuner circuit leaking into the satellite broadcast reception tuner circuit. Here, a quadrature detection circuit that performs direct conversion is counted as a kind of frequency conversion circuit, because it does perform frequency conversion.

To achieve the above object, according to another aspect of the present invention, a satellite and terrestrial broadcast reception integrated tuner is provided with: a satellite broadcast reception tuner circuit; and a terrestrial broadcast reception tuner circuit. Here, the ground pattern of the satellite broadcast reception tuner circuit and the ground pattern of the terrestrial broadcast reception tuner circuit are separated from each other. With this configuration, an unnecessary signal produced in the terrestrial broadcast reception tuner circuit is less likely to enter the satellite broadcast reception tuner circuit via ground. Thus, it is possible to reduce the degradation of characteristics caused by an unnecessary signal produced in the terrestrial broadcast reception tuner circuit leaking into the satellite broadcast reception tuner circuit.

To achieve the above object, according to another aspect of the present invention, a satellite and terrestrial broadcast reception integrated tuner is provided with: a satellite broadcast reception tuner circuit; a terrestrial broadcast reception tuner circuit; and a shielding member. Here, the shielding member is provided between the satellite broadcast reception tuner circuit and the terrestrial broadcast reception tuner circuit. With this configuration, it is possible to reduce the degradation of characteristics caused by an unnecessary signal produced in the terrestrial broadcast reception tuner circuit leaking into the satellite broadcast reception tuner circuit.

To achieve the above object, according to another aspect of the present invention, a satellite and terrestrial broadcast reception integrated tuner is provided with: a satellite broadcast reception tuner circuit; a terrestrial broadcast reception tuner circuit; and a circuit board. Here, the satellite broadcast reception tuner circuit is mounted on one side of the circuit board and the terrestrial broadcast reception tuner circuit is mounted on the other side of the circuit board. With this configuration, as compared with a case in which the satellite broadcast reception tuner circuit and the terrestrial broadcast reception tuner circuit are mounted on the same side of the circuit board, an unnecessary signal produced in the terrestrial broadcast reception tuner circuit is less likely to enter the satellite broadcast reception tuner circuit by propagating via space. Thus, it is possible to reduce the degradation of characteristics caused by an unnecessary signal produced in the terrestrial broadcast reception tuner circuit leaking into the satellite broadcast reception tuner circuit.

To achieve the above object, according to another aspect of the present invention, a satellite and terrestrial broadcast reception integrated tuner is provided with: a satellite broadcast reception tuner circuit; and a terrestrial broadcast reception tuner circuit. Here, the terrestrial broadcast reception tuner circuit includes: a filter circuit that attenuates a signal having a frequency outside the terrestrial broadcast reception band; and an RF amplifier to which the output of the filter circuit is directly inputted. With this configuration, an unnecessary signal (a signal having a frequency outside the terrestrial broadcast reception band) is less likely to enter the RF amplifier, and therefore an unnecessary harmonic is less likely to be produced in the RF amplifier. Thus, it is possible to reduce the degradation of characteristics caused by an unnecessary signal produced in the terrestrial broadcast reception tuner circuit leaking into the satellite broadcast reception tuner circuit.

### BRIEF DESCRIPTION OF THE DRAWINGS

FIG. 1 is a diagram schematically showing the configuration of the satellite and terrestrial broadcast reception integrated tuner of a first embodiment of the present invention;

FIG. 2 is a graph showing the characteristic of the filter circuit provided in the satellite and terrestrial broadcast reception integrated tuner shown in FIG. 1;

FIG. 3 is a diagram schematically showing the configuration of the satellite and terrestrial broadcast reception integrated tuner of a second embodiment of the present invention;

FIG. 4 is a diagram schematically showing the configuration of the satellite and terrestrial broadcast reception integrated tuner of a third embodiment of the present invention;

FIG. 5 is a diagram schematically showing the configuration of the satellite and terrestrial broadcast reception integrated tuner of a fourth embodiment of the present invention; and

FIG. 6 is a diagram schematically showing an example of the configuration of a conventional satellite and terrestrial broadcast reception integrated tuner.

### DETAILED DESCRIPTION OF PREFERRED EMBODIMENTS

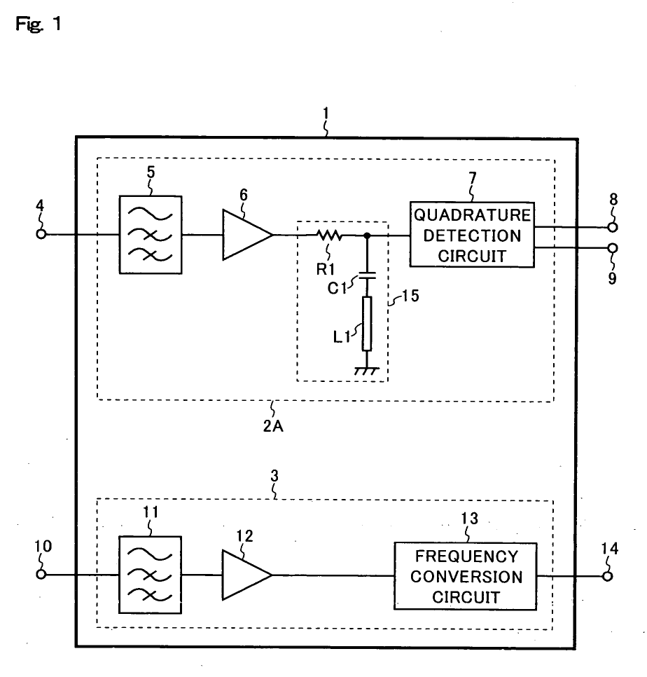

FIG. 1 schematically shows the configuration of the satellite and terrestrial broadcast reception integrated tuner of a first embodiment of the present invention. In FIG. 1, such parts as are found also in FIG. 6 are identified with common reference numerals and symbols, and no detailed explanations thereof will be repeated.

The satellite and terrestrial broadcast reception integrated tuner of the first embodiment of the present invention shown in FIG. 1 has a satellite broadcast reception tuner circuit 2A and a terrestrial broadcast reception tuner circuit 3 housed inside a shield case 1.

The satellite broadcast reception tuner circuit 2A is connected to an RF input terminal 4 and to output terminals 8 and 9, and includes a HPF 5, an RF amplifier 6, a filter circuit 15, and a quadrature detection circuit 7. An input signal fed in via the RF input terminal 4 first has its other than high-frequency components eliminated by the HPF 5, is then amplified by the RF amplifier 6, then has noise eliminated by the filter circuit 15, and is then converted by the quadrature detection circuit 7 into two baseband signals 90° out of phase with each other. The quadrature detection circuit 7 feeds one of the baseband signals to the output terminal 8 and the other to the output terminal 9.

Now, a description will be given of the filter circuit 15, as a feature unique to the satellite and terrestrial broadcast reception integrated tuner of the first embodiment of the present invention. The filter circuit 15 includes a resistor 9, a capacitor 10, and a pattern inductor L1.

When an input signal (a terrestrial broadcast signal) from the RF input terminal 10 is fed via the HPF 11 to the RF amplifier 12 and is amplified by the RF amplifier 12, harmonics of the terrestrial broadcast signal and frequency sum components among a plurality of terrestrial broadcast signals are produced. If these unnecessary signals leak into the satellite broadcast reception tuner circuit 2A, and if their frequencies are in the satellite broadcast reception band, they cause degraded characteristics. Even if the frequencies of such unnecessary signals are lower than the satellite broadcast reception band, if a plurality of them enters the quadrature detection circuit 7, and if their frequency sum components are in the satellite broadcast reception band, they cause degraded characteristics.

In view of the foregoing, in the satellite and terrestrial broadcast reception integrated tuner of the first embodiment of the present invention, to prevent as much as possible an unnecessary signal having a frequency lower than the satellite broadcast reception band from entering the quadrature detection circuit 7, the filter circuit 15 is provided in the stage preceding the quadrature detection circuit 7.

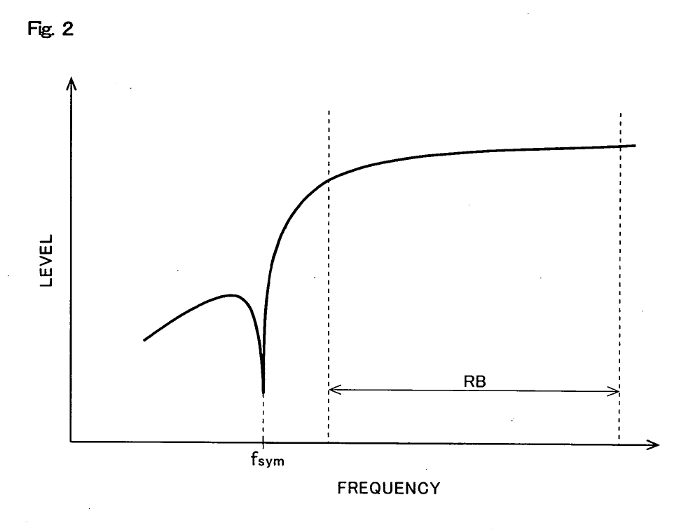

As shown in FIG. 2, the filter circuit 15 has its resonance frequency f_{sym} right below the satellite broadcast reception band RB, and is designed to function as a HPF. Thus, the filter circuit 15 sharply attenuates unnecessary signals having frequencies lower than the satellite broadcast reception band RB. In this way, it is possible to reduce the degradation of characteristics caused by an unnecessary signal produced in the terrestrial broadcast reception tuner circuit 3 leaking into the satellite broadcast reception tuner circuit 2A.

FIG. 3 schematically shows the configuration of the satellite and terrestrial broadcast reception integrated tuner of a second embodiment of the present invention. In FIG. 3, such parts as are found also in FIG. 6 are identified with common reference numerals and symbols, and no detailed explanations thereof will be repeated.

The satellite and terrestrial broadcast reception integrated tuner of the second embodiment of the present invention shown in FIG. 3 has a satellite broadcast reception tuner circuit 2, a terrestrial broadcast reception tuner circuit 3, and a partition plate 16 housed inside a shield case 1.

Now, a description will be given of the partition plate 16 and the grouped patterns of the two tuner circuits, as features unique to the satellite and terrestrial broadcast reception integrated tuner of the second embodiment of the present invention.

The partition plate 16 is an electrically conductive plate, and is provided between the satellite broadcast reception tuner circuit 2 and the terrestrial broadcast reception tuner circuit 3. Thus, the shield case 1 in combination with the partition plate 16 shields the satellite broadcast reception tuner circuit 2 and the terrestrial broadcast reception tuner circuit 3 separately from each other. In this way, it is possible to reduce the degradation of characteristics caused by an unnecessary signal produced in the terrestrial broadcast reception tuner circuit 3 leaking into the satellite broadcast reception tuner circuit 2. The partition plate 16 may be formed integrally with or separately from the shield case 1.

Moreover, in the satellite and terrestrial broadcast reception integrated tuner of the second embodiment of the present invention, the ground pattern of the satellite broadcast reception tuner circuit 2 and the ground pattern of the terrestrial broadcast reception tuner circuit 3 are separated from each other. With this configuration, an unnecessary signal produced in the terrestrial broadcast reception tuner circuit 3 is less likely to enter the satellite broadcast reception tuner circuit 2 via ground. Thus, it is possible to reduce the degradation of characteristics caused by an unnecessary signal produced in the terrestrial broadcast reception tuner circuit 3 leaking into the satellite broadcast reception tuner circuit 2.

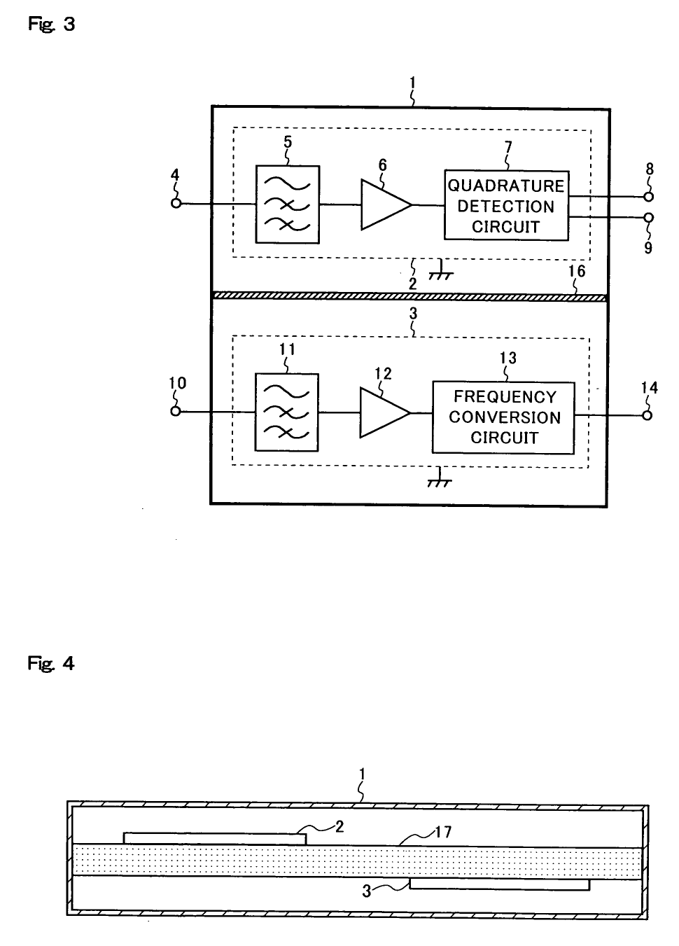

FIG. 4 schematically shows the sectional structure of the satellite and terrestrial broadcast reception integrated tuner of a third embodiment of the present invention. In FIG. 4, such parts as are found also in FIG. 6 are identified with common reference numerals and symbols, and no detailed explanations thereof will be repeated.

The satellite and terrestrial broadcast reception integrated tuner of the third embodiment of the present invention shown in FIG. 4 has a satellite broadcast reception tuner circuit 2, a terrestrial broadcast reception tuner circuit 3, and a circuit board 17 housed inside a shield case 1. The satellite broadcast reception tuner circuit 2 and the terrestrial broadcast reception tuner circuit 3 are mounted on the circuit board 17.

Now, a description will be given of how the satellite broadcast reception tuner circuit 2 and the terrestrial broadcast reception tuner circuit 3 are arranged, as a feature unique to the satellite and terrestrial broadcast reception integrated tuner of the third embodiment of the present invention. The satellite broadcast reception tuner circuit 2 is mounted on the top side of the circuit board 17, and the terrestrial broadcast reception tuner circuit 3 is mounted on the bottom side of the circuit board 17. Thus, as compared with a case in which the satellite broadcast reception tuner circuit 2 and the terrestrial broadcast reception tuner circuit 3 are mounted on the same side of the circuit board, an unnecessary signal produced in the terrestrial broadcast reception tuner circuit 3 is less likely to enter the satellite broadcast reception tuner circuit 2 by propagating via space. Thus, it is possible to reduce the degradation of characteristics caused by an unnecessary signal produced in the terrestrial broadcast reception tuner circuit 3 leaking into the satellite broadcast reception tuner circuit 2.

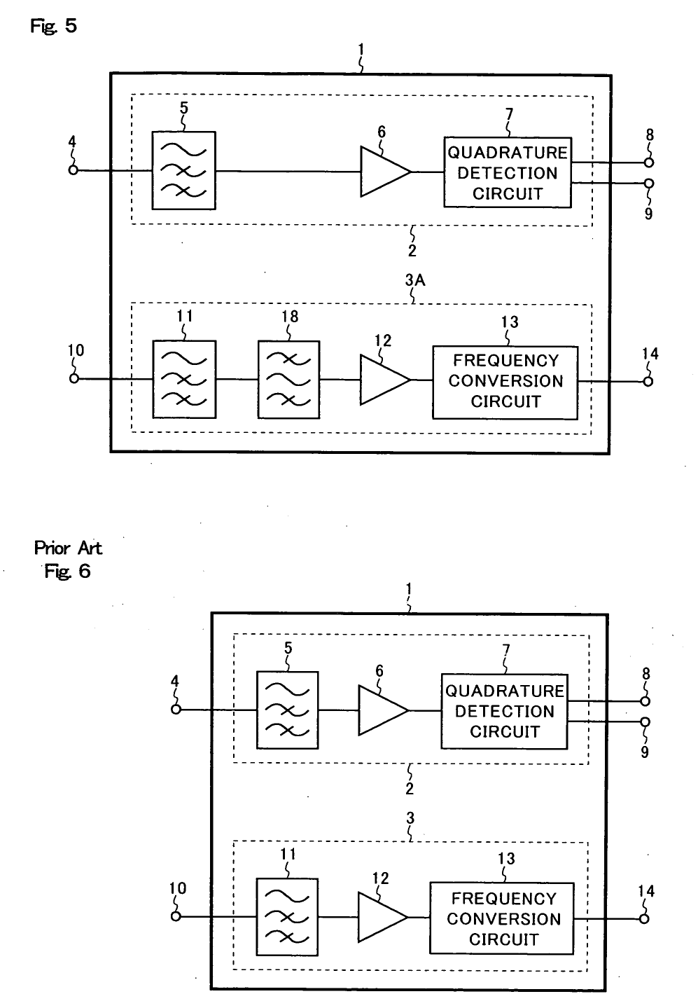

FIG. 5 schematically shows the configuration of the satellite and terrestrial broadcast reception integrated tuner of a fourth embodiment of the present invention. In FIG. 5, such parts as are found also in FIG. 6 are identified with common reference numerals and symbols, and no detailed explanations thereof will be repeated.

The satellite and terrestrial broadcast reception integrated tuner of the fourth embodiment of the present invention shown in FIG. 5 has a satellite broadcast reception tuner circuit 2 and a terrestrial broadcast reception tuner circuit 3A housed inside a shield case 1.

The terrestrial broadcast reception tuner circuit 3A is connected to an RF input terminal 10 and to an output terminal 14, and includes a HPF 11, a band-pass filter (hereinafter “BPF) 18, an RF amplifier 12, and a frequency conversion circuit 13. The frequency conversion circuit 13 includes, for example, a local oscillator, a PLL circuit that controls the local oscillator, and a mixer that mixes together the output of the RF amplifier 12 and the output of the local oscillator. An input signal fed in via the RF input terminal 10 first has its other than high-frequency components eliminated by the HPF 11, has then noise eliminated by the BPF 18, is then amplified by the RF amplifier 12, and is then down-converted by the frequency conversion circuit 13 into an IF signal. The frequency conversion circuit 13 feeds the IF signal to the output terminal 14.

Now, a description will be given of the BPF 18, as a feature unique to the satellite and terrestrial broadcast reception integrated tuner of the fourth embodiment of the present invention.

In the satellite and terrestrial broadcast reception integrated tuner of the fourth embodiment of the present invention, the BPF 18 is provided in the stage preceding the RF amplifier 12. Thus, an unnecessary signal (a signal having a frequency outside the terrestrial broadcast reception band) is less likely to enter the RF amplifier 12, and therefore an unnecessary harmonic is less likely to be produced in the RF amplifier 12. Thus, it is possible to reduce the degradation of characteristics caused by an unnecessary signal produced in the terrestrial broadcast reception tuner circuit 3A leaking into the satellite broadcast reception tuner circuit 2.

In the first to fourth embodiments described above, inside the shield case is provided no demodulation circuit for demodulating the output signal of the satellite broadcast reception tuner circuit and no demodulation circuit for demodulating the output signal of the terrestrial broadcast reception tuner circuit. Such demodulation circuits, however, may be provided inside the shield case; that is, a satellite and terrestrial broadcast reception integrated tuner according to the present invention may further include such demodulation circuits.

In the second embodiments described above, two features (specifically, the two tuner circuits being separated by the shielding plate, and the ground patterns of the tuner circuits being separated from each other) are practiced in combination. These features, however, may each be practiced singly.

All or part of the feature of the first embodiment, the two features of the second embodiment, the feature of the third embodiment, and the feature of the fourth embodiment of the present invention may be combined. For example, when the feature of the first embodiment and the feature of the fourth embodiment of the present invention are combined, the satellite and terrestrial broadcast reception integrated tuner has the satellite broadcast reception tuner 2A and the terrestrial broadcast reception tuner circuit 3A housed inside the shield case 1.

What is claimed is:

1. A satellite and terrestrial broadcast reception integrated tuner comprising:
a satellite broadcast reception tuner circuit; and
a terrestrial broadcast reception tuner circuit,
wherein the satellite broadcast reception tuner circuit includes:
a filter circuit that attenuates a signal having a frequency lower than a satellite broadcast reception band; and
a frequency conversion circuit to which an output of the filter circuit is directly inputted.

2. The satellite and terrestrial broadcast reception integrated tuner of claim 1,
wherein the filter circuit includes a resistor, a capacitor, and a pattern inductor, and is designed to function as a high-pass filter.

3. A satellite and terrestrial broadcast reception integrated tuner comprising:
a satellite broadcast reception tuner circuit; and
a terrestrial broadcast reception tuner circuit,
wherein a ground pattern of the satellite broadcast reception tuner circuit and a ground pattern of the terrestrial broadcast reception tuner circuit are separated from each other.

4. A satellite and terrestrial broadcast reception integrated tuner comprising:
a satellite broadcast reception tuner circuit;
a terrestrial broadcast reception tuner circuit; and
a shielding member,
wherein the shielding member is provided between the satellite broadcast reception tuner circuit and the terrestrial broadcast reception tuner circuit.

5. A satellite and terrestrial broadcast reception integrated tuner comprising:
a satellite broadcast reception tuner circuit;
a terrestrial broadcast reception tuner circuit; and
a circuit board,
wherein the satellite broadcast reception tuner circuit is mounted on one side of the circuit board and the terrestrial broadcast reception tuner circuit is mounted on another side of the circuit board.

6. A satellite and terrestrial broadcast reception integrated tuner comprising:
a satellite broadcast reception tuner circuit; and
a terrestrial broadcast reception tuner circuit,
wherein the terrestrial broadcast reception tuner circuit includes:
a filter circuit that attenuates a signal having a frequency outside a terrestrial broadcast reception band; and
an RF amplifier to which an output of the filter circuit is directly inputted.

7. The satellite and terrestrial broadcast reception integrated tuner of claim 6,
wherein the filter circuit is a band-pass filter.

8. The satellite and terrestrial broadcast reception integrated tuner of claim 1,
wherein the satellite broadcast reception tuner and the terrestrial broadcast reception tuner are housed inside a single shield case.

9. The satellite and terrestrial broadcast reception integrated tuner of claim 2,
wherein the satellite broadcast reception tuner and the terrestrial broadcast reception tuner are housed inside a single shield case.

10. The satellite and terrestrial broadcast reception integrated tuner of claim 3,
wherein the satellite broadcast reception tuner and the terrestrial broadcast reception tuner are housed inside a single shield case.

11. The satellite and terrestrial broadcast reception integrated tuner of claim 4,
wherein the satellite broadcast reception tuner, the terrestrial broadcast reception tuner, and the shielding member are housed inside a single shield case.

12. The satellite and terrestrial broadcast reception integrated tuner of claim 5,
wherein the satellite broadcast reception tuner, the terrestrial broadcast reception tuner, and the circuit board are housed inside a single shield case.

13. The satellite and terrestrial broadcast reception integrated tuner of claim 6,
wherein the satellite broadcast reception tuner and the terrestrial broadcast reception tuner are housed inside a single shield case.

14. The satellite and terrestrial broadcast reception integrated tuner of claim 7,
wherein the satellite broadcast reception tuner and the terrestrial broadcast reception tuner are housed inside a single shield case.
